(19) United States
(12) Patent Application Publication
(10) Pub. No.: US 2023/0145394 A1
(43) Pub. Date: May 11, 2023

(54) EDIBLE PRODUCTS

(71) Applicant: BAETEN & CO., Overmere (BE)

(72) Inventor: Matthias BAETEN, Gent (BE)

(21) Appl. No.: 17/907,851

(22) PCT Filed: Feb. 26, 2021
(86) PCT No.: PCT/EP2021/054920

§ 371 Date: Aug. 29, 2022

(30) Foreign Application Priority Data
Feb. 27, 2020 (BE) 2020/5133

(51) Int. Cl. A23P 20/10; A23L 5/10; A23L 19/18; A23L 3/36

(52) U.S. Cl. CPC A23P 20/11; A23L 5/10; A23L 19/18; A23L 3/36

(57) ABSTRACT

Pre-baked, edible product, suitable for being baked to completion in an oven or by using hot air, wherein the pre-baked, edible product comprises a coating layer, and wherein the pre-baked, edible product contains 2.5 to 20.0 wt. % of a glyceride composition, relative to the total weight of the pre-baked, edible product, wherein the glyceride composition comprises at least one lauric fat component and at least one liquid fat component, and wherein the coating layer comprises 75.0 to 100.0 wt. % of a fat composition, elative to the total weight of the coating layer, and wherein the fat composition of the coating layer is characterized by a content of from 35.0 to 80.0 wt. % of saturated fatty acid residues (SAFA) and less than 2.0 wt. % of trans fatty acid residues (TFA).

The present invention relates to pre-baked edible products, particularly pre-baked potato products, suitable for being baked to completion in an oven or by using hot air, whereby edible end products can be prepared having an optimal taste and texture, combined with an improved nutritional profile. The present invention also relates to a method for preparing these pre-baked edible products. The present invention also relates to the edible end products characterized by their appearance and sensory characteristics being fairly comparable to those of conventionally prepared edible products, where the baking process for the latter consists only of frying in oil or fat.

### 1. BACKGROUND OF THE INVENTION

Many edible products are produced by frying them in an oil bath, usually at temperatures between 150° C. and 200° C. The frying confers a pleasant texture to the product that can be described as crispy on the outside and soft and tender on the inside. Popular products of this kind are often potato-based, such as for instance French fries, croquettes, pommes duchesse, and the like.

Oil for deep frying is an ideal medium for a smooth heat transfer to the food product, so that a baked outer layer or crust is quickly formed, which is crispy and prevents the inside from drying out too much, so that the latter remains soft and tender. When the product is removed from the fryer, it is allowed to drip off, so that it will not absorb too much fat. However, it still contains a certain amount of frying oil or fat as its outer layer. In some cases, this confers a typical taste to the end product. In order to obtain the desired texture, taste and color, most potato products are deep-fried twice.

In addition to the home cooking of deep-fried edible products, in an industrial process, the edible products, particularly potato products, are deep-fried a first time, or pre-baked, in a bath of hot oil. These pre-baked deep-fried products are then deep-frozen, sold as such and stored in that condition by the consumer home, before baking them to completion a last time, and subsequently serving them. The final baking to completion by the consumer may however be carried out in two different ways. The pre-baked product is either submitted to a second round of deep frying, which is the most common method, or the product is finally baked to completion in an oven, in which case the product is referred to as e.g. “oven fries”, or by using hot air, such as in a hot air fryer.

In terms of taste, texture and appearance, the product that is deep-fried twice serves as a model: crispy on the outside, tender on the inside and a golden yellow in color. This requires, however, that the consumer has access to a deep fryer, which is a pan suitable for deep frying, in which the baking temperature can be set.

Typically, the frying oil or fat is used multiple times. The number of times is determined by the speed at which the oil or the fat degrades, due to the repeated or continuous heating. The repeated use of the frying oil or fat may also cause the typical taste imparted to the product by a specific fat to be slightly altered, or partly lost.

Many different oils and fats can be used for deep frying, both of vegetable and of animal origin. Popular frying oils for both industrial and domestic use are palm olein or a sunflower oil variety having a high oleic acid content. In the past, hardened fats were often used, more in particular partially hardened liquid oils, because of their improved oxidation and heat stability, but they are no longer used today due to their increased content of trans fatty acids. These have a very detrimental cardiovascular impact. Palm olein and the sunflower oil variety are both low in polyunsaturated fatty acids, and therefore more resistant to heating.

Today, coconut oil is enjoying increasing popularity in its use for deep frying, but also in many other food applications. In addition, coconut oil is also resistant to heating. Coconut oil imparts a typical, pleasant and recognizable taste to the end product. In addition to its typical taste, coconut oil also has a very pleasant mouthfeel, as it melts quickly and completely at body temperature and therefore exhibits a cool-melting behavior. This is used, for example, in confectionery applications.

Coconut oil is solid at room temperature and is naturally highly stable; this is due to its high content of saturated fatty acids, about 90 wt. %. Contrary to most other oils and fats, no hardening process needs to be carried out in order to obtain these characteristics.

Coconut oil is free from trans fatty acids, has a low content of palmitic acid (C16-0), which is known to be atherogenic, and coconut oil is also a source of medium length, so-called “medium chain” fatty acids such as caprylic acid and capric acid. On the other hand, coconut oil is highly saturated, over 90 wt. %, and for that reason, its nutritional quality is being questioned by a number of researchers. In Nutrition Reviews, Volume 74, Issue 4, April 2016, Pages 267-280, Laurence Eyres, Michael F. Eyres, Alexandra Chisholm, Rachel C. Brown, in the review article “Coconut oil consumption and cardiovascular risk factors in humans”, conclude that, despite the fact that coconut oil is strongly promoted as a healthy oil with the benefit of supporting cardiac health, there is no convincing evidence for the claim that consumption of coconut oil, contrary to the consumption of unsaturated oils, would lead to an improved lipid profile and a reduced risk of cardiovascular disease. They further state that the intervention studies show that replacing coconut oil by cis-unsaturated fats would consistently alter the lipid profile in the blood, leading to a reduction of risk factors for cardiovascular disease.

In spite of this, coconut oil is enjoying increasing popularity in its use for deep frying, but also in many other food applications. Yet there is clearly also a need for nutritional optimization of this coconut oil, while still retaining its pleasant characteristics. To this end, coconut oil is often combined with liquid oils rich in mono-unsaturated fatty acids (MUFA) and polyunsaturated fatty acids (PUFA). PUFA have the advantage over MUFA that they lower cholesterol even more, but PUFA especially suffers from stability issues with multiple uses in frying applications.

A second serious problem that arises when using combinations of coconut oil with liquid oil in frying applications is their strong tendency to foam upon heating. A number of researchers have looked into this phenomenon, including M-A Kim et Al., Agricultural and Biological Chemistry, 52:3, 693-699, 1988. According to these researchers, the problem of foaming is caused by the large difference in chain length between the triglycerides of the coconut oil in comparison to liquid oils. Coconut oil is indeed rich in lauric acid with a chain length of 12 carbon atoms, and contains a high number of triglycerides having medium-length fatty acid chains of 8, 10 and 12 carbon atoms, respectively, while liquid oils mainly contain fatty acid residues with a chain length of 18 carbon atoms (namely, C18:0, C18:1, C18:2, and C18:3). The authors have studied different combinations of lauric fats (coconut oil and palm kernel oil) with liquid oils: this showed that the combination coconut oil/corn oil in a 50/50 ratio has the strongest tendency to foam. The same researchers have shown that chemical interesterification (randomization) of the mixture may provide a solution to this problem. This chemical reaction indeed causes a random rearrangement of the fatty acids on the glycerin base structure, leading to a more even distribution in the chain length of the triglycerides. On the other hand, this interesterification also leads to the formation of triglycerides having a carbon number of 42-48, which are not or hardly present in the original mixture.

Although this step of randomization seems to offer a solution to the problem of foaming, it also introduces new disadvantages that make this solution unacceptable. Firstly, there is the process of chemical interesterification, which is considered unnatural by the consumer and makes the product a form of industrially treated (“processed”) food. Furthermore, a modification occurs that causes the coconut oil to lose its typical features. For example, coconut oil typically has a triglyceride composition having a high content of short fatty acid chains (i.e. carbon number 34-36) which yields the pleasant mouthfeel (including melting behavior), but after interesterification, this is largely eliminated. Moreover, a mixture that is interesterified needs to be refined both before and after the interesterification. This usually involves a treatment at high temperature and deep vacuum. In this step, the typical taste of the coconut oil may be lost. Finally, the suggested process step does not offer a solution for the oxidation stability with multiple uses at high temperature in the presence of a substantial amount PUFA, on the contrary: chemical interesterification causes a number of naturally occurring anti-oxidants to be partly destroyed.

Another solution sometimes proposed for the problem of foaming is to add anti-foaming agents to the frying oils, such as e.g. silicones, but those carry E-numbers and are not wanted by the consumer. The consumer desires a so-called “clean label”. They are also only able to solve the problem in a very partial way and are insufficient in severe cases.

In other words, as described above, a problem arises if one wishes to use coconut oil or another lauric fat as a deep frying fat in a nutritionally responsible manner. This problem occurs in both domestic and industrial preparation of deep-fried products.

As already indicated above, the final baking to completion of industrially deep-frozen deep-fried products by the consumer can be carried out in two different ways. The product is either submitted to a second round of deep frying, which is the most common method, or the product is finally baked to completion in an oven, in which case the product is referred to as e.g. “oven fries”, or by using hot air, such as in a hot air fryer.

Baking to completion in an oven or by using hot air has significant advantages, such as for example ease of use and safety, no waste oil, lower fat content of the end product, lower intake of oxidized fat components from the frying oil, as the deep frying always results in a certain amount of frying oil or fat as an outer layer. In this method, the greatest challenge lies in obtaining a taste, texture and appearance that are as close as possible to those of double deep-fried products.

There is an increased interest in baking pre-baked deep-fried products, e.g. potato products, to completion in an oven or by using hot air.

A frequently used technique to provide these products, e.g. potato products, with their desired final texture is to first deep fry the products and then coat them, or vice versa. Optionally, they are additionally deep-frozen. The coating is often carried out by means of starch products, polysaccharides, hydrocolloids, and the like. These form a crust and give the outside a crispy texture, while the inside is protected against drying out when baked to completion in the oven. An example of this is described in WO 2005/117604. Potato strips are first blanched and dried, after which they are coated with a batter and baked by frying them, e.g. in canola oil, and finally, they are deep frozen. This method has the disadvantage of being rather laborious and complex.

In U.S. Pat. No. 3,865,964, and later in WO 97/40711, WO 97/40712 and CA 1064764, a different approach is put forward, in which, after the first round of baking by deep frying, the product is coated with a layer of fat.

U.S. Pat. No. 3,865,964 describes how a thin coating of fat is applied onto pre-baked, deep-frozen French fries, allowing the final preparation in an oven by the user, so as to simulate the effect of a final preparation by deep frying. The inventors do not specify the frying oil used for the first round of baking; for coating the frozen French fries, it is preferable to use a fat that immediately solidifies upon cooling, and more in particular, it is preferable to use 100% partially hardened soybean oil. As indicated above, such fats contain a high content of trans fatty acids, with very adverse health effects.

WO 9740711 and WO 9740712 claim to have achieved an improvement in relation to the prior art, especially in terms of the final texture, taste and color obtained of the oven-baked potato product, owing to a better control of the moisture content of the pre-baked product and of the fat content added when coating this product. The oven-baked potato product is described as golden brown in color, having a crispy crust and a moist inside. The pre-baked potato product preferably contains 12 to 18% of fat, and is then optionally deep-frozen, after which it is coated with a layer of fat sufficient in amount to prevent a rapid moisture migration of the product when baking to completion in the oven. This amount is 2 to 15%, expressed relative to the total pre-baked, coated product. The total fat content of this product is 8 to 30 wt. %, preferably 16 to 24 wt. %. According to WO 9740711 and WO 9740712, a wide range of oils and fats can be used for deep frying and coating the product, including vegetable and animal, unmodified or modified, for example by hydrogenation, but also synthetic fats as well as fat substitutes, such as for example sucrose polyesters. In the examples, where only vegetable oils and fats are used, partially hardened combinations of soybean oil and corn oil are always employed, both when pre-baking and for coating. These are again fats having a high content of trans fatty acids, which suggests that in WO 9740711 and WO 9740712 only the desired final physical characteristics are taken into account, without paying attention to nutritional quality.

CA 1064764 also claims to have found an improvement in relation to U.S. Pat. No. 3,865,964, especially regarding homogeneity in color and crispiness of the end product. To this end, only a very thin layer of fat is applied onto the pre-baked and then deep-frozen French fries, being less than 1% of the end product. in order to achieve this, an apparatus is used that can atomize the fat into very small droplets that adhere to the frozen product and then solidify in a matter of seconds. CA 1064764 explains that a wide range of oils and fats can be used for the coating, including partially hardened soy, palm, coconut, peanut and rapeseed oil. In the example, palm oil is used. it is clear that in this case, too, there is no optimization of the nutritional quality. Palm oil is highly rich in palmitic acid (C16-0) which has a strong cholesterogenic effect, more particularly increasing the level of undesirable LDL cholesterol in the blood. Furthermore, palm products, such as palm oil and palm kernel oil, are increasingly criticized for being a threat to biodiversity. Palm is produced in large plantations, for which tropical forests are often cut down, and thus poses a threat to nature. Coconut oil, on the other hand, is produced and cultured on a much smaller scale, without being a threat to nature.

The above shows that there is a need for pre-baked edible products, preferably potato products, suitable for baking to completion in an oven or by using hot air, said products comprising a coating layer that mainly consists of an oil and/or a fat, having a balanced nutritional composition, and wherein the edible end products made thereof and baked to completion have an optimal taste and texture, combined with an improved nutritional profile.

### 2. SUMMARY OF THE INVENTION

The inventors have now surprisingly found that it is possible to provide a pre-baked, edible product, suitable for baking to completion in an oven or by using hot air, which fulfills the above-mentioned needs.

It is therefore an aim of the present invention to provide a pre-baked, edible product, suitable for being baked to completion in an oven or by using hot air, wherein the pre-baked, edible product comprises one or more coating layers [hereinafter “coating layer”] and wherein the pre-baked, edible product contains 2.5 to 20.0 wt. % of a glyceride composition, relative to the total weight of the pre-baked, edible product, wherein the glyceride composition comprises at least one lauric fat component and at least one liquid fat component, and wherein the glyceride composition contains, relative to the weight of the glyceride composition:
a) 5.0 to 35.0 wt. % of saturated C12 fatty acid residues (C12:0),
b) less than 12.0 wt. % of saturated C16 fatty acid residues (C16:0),
c) 30.0 to 80.0 wt. % of saturated and unsaturated C18 fatty acid residues (C18)
d) 20.0 to 70.0 wt. % of saturated fatty acid residues (SAFA),
e) less than 2.0 wt. % of trans fatty acid residues (TFA)
f) saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 37.0,
g) saturated C14 fatty acid residues (C14:0), saturated C16 fatty acid residues (C16:0), and saturated fatty acid residues (SAFA), in a weight ratio of (C14:0+C16:0)/SAFA of less than 50.0.
   and wherein the coating layer comprises 75.0 to 100.0 wt. % of a fat composition, relative to the total weight of the coating layer, and wherein the fat composition of the coating layer is characterized by a content of from 35.0 to 80.0 wt. % of saturated fatty acid residues (SAFA) and less than 2.0 wt. % of trans fatty acid residues (TFA).

It is also an aim of this invention to provide a method for producing this pre-baked, edible product.

It is also an aim of this invention to provide an edible product baked to completion, produced by baking such a pre-baked, edible product to completion.

### 3. DETAILED DESCRIPTION OF THE INVENTION

Within the scope of this invention, the following concepts and definitions are used.

The expression “deep frying” refers to baking an edible product, particularly a potato product, by submerging it in a bath of hot oil and/or fat, usually at temperatures between 150 and 200° C.

Within the scope of this invention, it is understood that a deep-fried edible product refers to an edible product deep-fried once or multiple times. Furthermore, these deep-fried edible products may be finished edible products, ready for consumption, as well as semi-finished products, such as for example frozen French fries, which are for example pre-baked at least once in a deep fryer, and which still need to undergo a final baking step before use, by deep frying them again or otherwise.

Within the scope of this invention, it is understood that a deep-fried potato product refers to a deep-fried edible product consisting of potato as an ingredient, either entirely or for more than 75 wt. %, preferably for more than 85 wt. %, or preferably for more than 90 wt. %. The potato may have already undergone standard processing before the deep frying. Standard processing may for instance refer to peeling and cutting to pieces, blanching, puréeing.

The expression “pre-baking” refers to baking or at least partly baking an edible product in advance, making it into a semi-finished product, which needs to undergo at least one additional baking step before being ready for consumption.

The expression “baking to completion” refers to the final baking steps before being ready for consumption. These may for example take place by means of a deep frying step, or by baking or heating in an oven, such as a microwave oven, a conventional oven, a hot air oven, or by baking in a hot air fryer or in a comparable appliance or a grill device.

Within the scope of this invention, it is understood that an oven-baked edible product refers to an edible product that has already been pre-baked, preferably by deep frying, and is to be baked to completion in an oven. Oven fries are an example of such oven-baked edible products.

Within the scope of this invention, the terms “oils” and “fats” will be used interchangeably. The oils or fats comprised in the different ingredients form the glyceride composition described above. These oils or fats may be of vegetable or animal origin, or any combination thereof.

Within the scope of this invention, it is understood that the expression “the pre-baked, edible product comprises one or more coating layers” refers to a pre-baked, edible product having been subjected to a specific step of coating or enrobing, causing one or more coating layers to be formed on the pre-baked, edible product in this specific step. This specific step of coating or enrobing is for example intended to mean spraying, submerging, daubing, and the like, of the pre-baked, edible product.

It goes without saying that the layer of oil or fat that is present on the edible product after pre-baking in a deep fryer cannot be considered a coating layer, as it is not the result of such a specific step of coating or enrobing.

Within the scope of this invention, it is also understood that the fat composition comprised in the coating layer, as described above, is part of the glyceride composition described above.

Within the scope of this invention, it is understood that the expression “coating layer” refers to both one or more coating layers, and that coating layer should be understood both in the singular and in the plural.

Within the scope of this invention, it is also understood that the expression “the coating layer comprises 75.0 to 100.0 wt. % of a fat composition, relative to the total weight of the coating layer” refers to the amount of the fat composition present in one coating layer when the pre-baked, edible product comprises only one coating layer, or refers to the sum of all amounts of fat compositions present in the different coating layers in case multiple coating layers are present.

Preferably, the one or more coating layers [hereinafter “coating layer”] as described above comprises, relative to the total weight of the coating layer:
i. 75.0 to 100.0 wt. % of the fat composition, as described above,
ii. 0 to 25.0 wt. % of a fat-free portion [hereinafter “dry filler”],
iii. optionally, at most 15 wt. % of water.

Furthermore, in the text, the oils and fats that are not part of the coating layer, such as for example the layer of oil or fat that is present on the edible product after pre-baking in a deep fryer, will be referred to as “added fat composition”. It therefore goes without saying that the added fat composition is also part of the glyceride composition.

Furthermore, in the text, the oils and fats already present in the edible product that has not yet been pre-baked, such as for example the fat in the cheese in cheese croquettes, will be referred to as “fat native to the product”. It therefore goes without saying that the fat native to the product is also part of the glyceride composition.

This being said, the fat components comprised in the glyceride composition may therefore, in addition to the fat composition comprised in the coating layer, the added fat composition, also contain fats native to the product.

Glyceride composition is intended to mean the sum of mono-, di- and triglycerides present.

Within the scope of this invention, it is understood that liquid oil or liquid fat refers to an oil or fat having a melting point of less than 25.0° C.

According to the present invention, the pre-baked, edible product, suitable for being baked to completion in an oven or by using hot air, comprises one or more coating layers [hereinafter “coating layer”], contains 2.5 to 20.0 wt. % of a glyceride composition, relative to the total weight of the pre-baked, edible product, wherein the glyceride composition comprises at least one lauric fat component and at least one liquid fat component, and the glyceride composition contains, relative to the weight of the glyceride composition:
a) 5.0 to 35.0 wt. % of saturated C12 fatty acid residues (C12:0),
b) less than 12.0 wt. % of saturated C16 fatty acid residues (C16:0),
c) 30.0 to 80.0 wt. % of saturated and unsaturated C18 fatty acid residues (C18)
d) 20.0 to 70.0 wt. % of saturated fatty acid residues (SAFA),
e) less than 2.0 wt. % of trans fatty acid residues (TFA)
f) saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 37.0,
g) saturated C14 fatty acid residues (C14:0), saturated C16 fatty acid residues (C16:0), and saturated fatty acid residues (SAFA), in a weight ratio of (C14:0+C16:0)/SAFA of less than 50.0,
   and wherein the coating layer comprises 75.0 to 100.0 wt. % of a fat composition, relative to the total weight of the coating layer, and wherein the fat composition of the coating layer is characterized by a content of from 35.0 to 80.0 wt. % of saturated fatty acid residues (SAFA) and less than 2.0 wt. % of trans fatty acid residues (TFA).

The pre-baked edible products according to the present invention, as described above, particularly pre-baked potato products, having an additional coating layer applied thereon, can be baked to completion in an oven or by using hot air for forming edible end products baked to completion, which thereby have the desired taste and texture, particularly by the presence of a minimal amount of a lauric fat in combination with one or more oils having a low saturated fat content. The lauric fat is preferably coconut oil.

The inventors have found that the presence of a certain amount of saturated C12 fatty acid residues (C12:0), and a minimal content of saturated fatty acid residues (SAFA), produces a certain structure. In addition to taste and texture, an optimal nutritional quality is simultaneously pursued; this is achieved by a maximum content of saturated fatty acid residues (SAFA) and trans fatty acid residues (TFA), a maximum content of saturated C16 fatty acid residues (C16:0) and a maximum ratio of (C14:0+C16:0)/SAFA. Both C14:0 and C16:0 have a strongly increasing effect on the LDL cholesterol level, and are therefore undesired.

Furthermore, the pre-baked edible products according to the present invention are characterized by a minimal content of saturated and unsaturated C18 fatty acid residues (C18). Unsaturated fatty acid residues with a chain length of 18 carbon atoms (i.e. C18:1; C18:2 and C18:3) are cholesterol-lowering, while saturated fatty acid residues with a chain length of 18 carbon atoms (C18:0) have a cholesterol neutral effect.

A weight ratio of (C6:0+C8:0+C10:0+C12:0)/SAFA of at least 37 means that the saturated C6 fatty acid residues (C6:0), saturated C8 fatty acid residues (C8:0), saturated C10 fatty acid residues (C10:0), saturated C12 fatty acid residues (C12:0) need to be present in a certain amount. These are known as the so-called medium-length chain fatty acids or “Medium Chain” fatty acids. These have a positive connotation.

In the pre-baked, edible product according to the present invention, the glyceride composition preferably contains from 7.0 to 30.0 wt. %, preferably from 9.0 to 28.0 wt. %, preferably from 10.0 to 25.0 wt. %, of saturated C12 fatty acid residues (C12:0), based on the total weight of the glyceride composition.

In the pre-baked, edible product according to the present invention, the glyceride composition preferably contains less than 10.0 wt. % of saturated C16 fatty acid residues (C16:0), based on the total weight of the glyceride composition.

In the pre-baked, edible product according to the present invention, the glyceride composition preferably contains from 35.0 to 77.0 wt. %, preferably from 40.0 to 75.0 wt. %, preferably from 45.0 to 73.0 wt. %, of saturated and unsaturated C18 fatty acid residues (C18), based on the total weight of the glyceride composition.

In the pre-baked, edible product according to the present invention, the glyceride composition preferably contains from 25.0 to 65.0 wt. %, preferably from 30.0 to 60.0 wt. %, preferably from 32.0 to 55.0 wt. %, of saturated fatty acid residues (SAFA), based on the total weight of the glyceride composition.

In the pre-baked, edible product according to the present invention, the glyceride composition preferably contains less than 1.0 wt. % of trans fatty acid residues (TFA), based on the total weight of the glyceride composition.

In the pre-baked, edible product according to the present invention, the glyceride composition preferably contains a weight ratio of (C6:0+C8:0+C10:0+C12:0)/SAFA of more than 40.0, preferably more than 45, preferably more than 50.

In the pre-baked, edible product according to the present invention, the glyceride composition preferably contains a weight ratio of (C14:0+C16:0)/SAFA of less than 45.0, preferably less than 40.

Finally, the nutritional quality of the pre-baked, edible product according to the present invention will also depend on the weight amount of the glyceride composition, as described above, based on the total weight of the pre-baked, edible product. Preferably, the pre-baked, edible product, relative to the total weight of the pre-baked, edible product, preferably contains from 3.5 to 15.0 wt. % of the glyceride composition, preferably from 4.0 to 12.0 wt. %.

The content of the glyceride composition will partly depend on the nature of the coating layer applied onto the pre-baked, edible product and the method used.

It goes without saying that when the coating layer, as described above, contains 100.0 wt. % of the fat composition, relative to the weight of the coating layer, this will result in a higher total content of the glyceride composition.

The inventors have thus found that the presence in the pre-baked, edible product according to the present invention, of a correct combination of oils and fats in accordance with the above characteristics, allows an optimum to be achieved in nutritional quality and in desired physical and organoleptic properties of the edible end product baked to completion. More in particular, the inventors have surprisingly found that by nutritional optimization of the glyceride composition, a functional improvement could be achieved as well, in that a product could be made that is closer in terms of characteristics to the reference product, being the classical edible products baked to completion in a deep fryer.

In preferred embodiments, in the pre-baked, edible product according to the present invention, the glyceride composition contains triglycerides characterized by a carbon number (CN) substantially having a length of between 44 carbon atoms (C44) and 48 carbon atoms (C48), wherein the total content of triglycerides having a carbon number of 44 (C44), 46 (C46) and 48 (C48) (i.e. C44+C46+C48) is less than 15.0 wt. %, preferably less than 10.0 wt. %, based on the total weight of the glyceride composition.

Triglycerides having a carbon number of 44 (C44), 46 (C46) and 48 (C48) are usually derived from fat mixtures they have been interesterified, usually fat mixtures that are simultaneously rich in fatty acid chains having a medium chain length and in fatty acid chains having a length of 18 C-atoms. This interesterification involves a modification that is not desired here, because of a number of favorable characteristics of the lauric fat, particularly coconut oil, are lost as a result. Triglycerides having a carbon number 48 (C48) may also be derived from palm oil or palm oil stearins, due to the tri-palmitin present therein. This is not desirable from a nutritional point of view, and the taste and mouthfeel are also adversely affected by it, as they are triglycerides that do not melt at body temperature.

As described above, the coating layer comprises, relative to the total weight of the coating layer:
i. 75.0 to 100.0 wt. % of the fat composition, as described above,
ii. 0 to 25.0 wt. % of a fat-free portion [hereinafter “dry filler”],
iii. optionally, at most 15 wt. % of water,
   and wherein the fat composition of the coating layer is characterized by a content of from 35.0 to 80.0 wt. % of saturated fatty acid residues (SAFA) and less than 2.0 wt. % of trans fatty acid residues (TFA).

In a preferred embodiment, said fat composition in the coating layer contains at least one lauric fat component and at least one liquid fat component. The lauric fat component is preferably coconut oil.

In preferred embodiments, the fat composition present in the coating layer of the pre-baked, edible product of the present invention further contains, relative to the total weight of the fat composition:
A. 10.0 to 45.0 wt. % of saturated C12 fatty acid residues (C12:0),
B. less than 15.0 wt. % of saturated C16 fatty acid residues (C16:0),
C. saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 45.0,
D. triglycerides having a carbon number of 44 (C44), 46 (C46) and 48 (C48), of which the total content of C44, C46 and C48 is less than 15.0 wt. %.

In the pre-baked, edible product according to the present invention, the fat composition present in the coating layer preferably contains from 20.0 to 40.0 wt. %, preferably from 25.0 to 38.0 wt. %, of saturated C12 fatty acid residues (C12:0), based on the total weight of the fat composition.

In the pre-baked, edible product according to the present invention, the fat composition present in the coating layer preferably contains less than 12.0 wt. % of saturated C16 fatty acid residues (C16:0), based on the total weight of the fat composition.

In the pre-baked, edible product according to the present invention, the fat composition present in the coating layer preferably contains from 45.0 to 75.0 wt. %, preferably from 50.0 to 70.0 wt. %, of saturated fatty acid residues (SAFA), based on the total weight of the fat composition.

In the pre-baked, edible product according to the present invention, the fat composition present in the coating layer preferably contains less than 1.0 wt. % of trans fatty acid residues (TFA), based on the total weight of the fat composition.

In the pre-baked, edible product according to the present invention, the fat composition present in the coating layer preferably contains a weight ratio of (C6:0+C8:0+C10:0+C12:0)/SAFA of more than 55.0.

In the pre-baked, edible product according to the present invention, the total content of C44, C46 and C48 in the fat composition present in the coating layer is less than 10.0 wt. %, based on the total weight of the fat composition.

An advantage of the present invention when compared to the classical edible products baked to completion by using a deep fryer, where deep frying is carried out twice, is that the fat composition present in the coating layer of the pre-baked, edible product can be richer in poly-unsaturated fatty acid residues (PUFA). This is because the baking to completion of the pre-baked, edible product in the oven or by using hot air is a less critical step in terms of stability than a second deep frying, especially since the fat is only used once.

Preferably, the fat composition present in the coating layer has a weight ratio of poly-unsaturated fatty acid residues (PUFA)/mono-unsaturated fatty acid residues (MUFA) of at least 0.5 and at most 2.5, preferably at least 1.0 and at most 2.0.

Moreover, when foaming occurs during deep frying, there is an increased risk of rapid oxidation. Even when pre-baking the edible product is carried out by deep frying, during this deep frying, which preferably takes place at a not too high temperature, frying oils having a relatively high content of PUFA can be used. This is because the layer of frying oil remaining on the pre-baked, edible product afterward, is coated with the coating layer, which benefits the stability during storage.

Preferably, the glyceride composition in the pre-baked, edible product according to the present invention has a weight ratio of poly-unsaturated fatty acid residues (PUFA)/mono-unsaturated fatty acid residues (MUFA) of at least 0.5 and at most 2.5, preferably at least 1.0 and at most 2.0, even more preferably at least 1.2 and at most 1.8.

In other words, the pre-baked, edible product according to the present invention, when compared to the classical edible products baked to completion by using a deep fryer, has additional nutritional benefits in terms of an increased presence of PUFA relative to MUFA. PUFA offer the advantage that they lower the cholesterol level in the blood more strongly than MUFA. It should further be understood that an upper limit for this weight ratio PUFA/MUFA is preferable for reasons of stability the product.

In the pre-baked, edible product according to the present invention, the coating layer preferably comprises, relative to the weight of the coating layer, 80.0 to 100.0 wt. %, more preferably 90.0 to 100.0 of the fat composition, as described above.

The fat composition present in the coating layer of the pre-baked, edible product according to the present invention is also characterized by an optimum in nutritional quality and exhibits the desired physical and organoleptic properties.

If so desired, the fat composition present in the coating layer of the pre-baked, edible product according to the present invention further comprises one or more additives, such as emulsifiers, anti-oxidants, thickeners, and the like in an amount of less than 5 wt. %, preferably less than 2 wt. %, relative to the total weight of the fat composition.

The inventors have thus found that the presence in the coating layer, in the pre-baked, edible product according to the present invention, of an optimal amount lauric fat in combination with an optimal amount of low-saturated oils, lowering the content of saturated fatty acid residues relative to the pure lauric fat, as described above, lends a certain structure to the edible end product baked to completion, formed after baking to completion in the oven or by using hot air.

As described above, the coating layer envelops the pre-baked edible product, preferably a pre-baked potato product. In general, the edible product, preferably a potato product, is first deep-fried in a liquid oil. This liquid oil, which is present on pre-baked edible product after deep frying, is then enveloped by the coating layer, as described above, which preferably contains a higher content of saturated fatty acid residues (SAFA) than that liquid oil, so as to obtain a desired final texture.

Preferably, the pre-baked edible product of the present invention contains, relative to the total weight of the pre-baked edible product, 2.0 to 17.0 wt. %, preferably 3.0 to 12.0 wt. %, %, preferably 2.5 to 8.0 wt. %, of the coating layer, as described above.

The inventors have thus surprisingly found that by using combinations of at least one lauric fat, particularly coconut oil, with at least one liquid oil as the fat components in the coating layer, the pre-baked, edible products according to the present invention, after baking to completion, are characterized by a crispy outside, combined with a pleasant, tender, creamy inner texture. Referring to the examples, it was surprisingly found that when coconut oil was used in combination with a liquid oil instead of pure coconut oil alone, the edible end products baked to completion clearly scored better organoleptically. This is surprising, as a fat composition consisting of pure coconut oil contains the highest content of solid fat, and therefore should score better when it comes to crispiness, but this was clearly not the case. Moreover, the pre-baked, edible products according to the present invention coated with pure coconut oil, after baking to completion, had a noticeably dryer inner texture. Thus, on both parameters, the pre-baked, edible products with the pure coconut oil coating layer differed from classical edible products baked to completion in a deep fryer, such as for example potato fries.

It was thus found that it is possible to simultaneously achieve both a nutritional and a functional improvement, and that this can surprisingly be achieved with the pre-baked, edible products according to the present invention described above, without these having to be conflicting interests.

According to a preferred embodiment, the fat composition present in the coating layer of the pre-baked, edible product, according to the present invention, comprises, relative to the total weight of the fat composition,
a) 30.0 to 85.0 wt. % of coconut oil or at least one fraction of coconut oil, or combinations thereof, preferably from 50.0 to 75.0 wt. %, and
b) 15.0 to 70.0 wt. % of at least one liquid oil, preferably from 25.0 to 50.0 wt. %.

Coconut oil offers the advantage that it is richer in medium-length fatty acid residues than palm kernel oil.

According to a particular embodiment, cold-pressed coconut oil, or the so-called “virgin” coconut oil, can be used. This coconut oil has retained its original taste and aroma, as it has not been subjected to high temperature processing.

In general, for liquid oil, different types and combinations of types may be suitable, such as for example, but not limited to, corn oil, soybean oil, sunflower oil, rapeseed oil, peanut oil, cottonseed oil, and the like, as well as varieties of these oils, such as for example sunflower oil having an increased content of oleic acid.

If so desired, the fat composition present in the coating layer of the pre-baked, edible product according to the present invention may comprise other oils and fats different from coconut oil and the liquid oil, in an amount of less than 30.0 wt. %, preferably less than 25.0 wt. %, relative to the total weight of the fat composition.

Non-limiting examples of other oils and fats are shea butter, sal fat, palm oil or fractions of the above, for example olein fractions, as these are less saturated. Animal fats, such as beef fat, pork fat, mutton fat, chicken fat, duck fat, goose fat, and the like, may also be used to a limited extent, usually with the aim of imparting a certain taste to the edible products baked to completion.

According to a further preferred embodiment, the glyceride composition in the pre-baked, edible product according to the present invention preferably comprises substantially no hardened fat components. Edible products consisting of hardened fat components must be labeled, and the consumer tends to avoid such products, as they have an unhealthy and unnatural image.

According to a further preferred embodiment, the glyceride composition in the pre-baked, edible product according to the present invention preferably comprises substantially no palm oil or palm kernel oil, or fractions of these oils. Palm products do not have a healthy image and they are increasingly seen as a threat to biodiversity.

According to a further preferred embodiment, the glyceride composition in the pre-baked, edible product according to the present invention preferably comprises substantially no animal fat components.

As described above, the pre-baked, edible product according to the present invention is preferably a pre-baked potato product, or a pre-baked, edible product that substantially consists of potatoes, or a pre-baked, edible product derived from potatoes. Pre-baked potato products are a very popular product due to their attractive taste, texture and price, and because of the ease of use in further preparations.

Preferably, the pre-baked, edible product according to the present invention is a deep-fried edible product. Within the scope of this present invention, this means that in pre-baking or at least partly pre-baking an edible product, at least one deep frying step was used. The deep frying offers the advantage that it already lends a certain taste and texture to the pre-baked, edible product. Furthermore, it is a way to bake the edible product in a highly homogenous way, and the at least one deep frying step can easily be carried out on a large scale in specially designed industrial installations.

Preferably, the deep-fried edible products according to this invention belong to the group of French fries, croquettes, pommes archiduc, deep-fried potatoes or potato pieces and the like.

As described above, the fat components comprised in the glyceride composition of the pre-baked, edible product according to the present invention may thus be derived from the added fat composition, of from the fats native to the product, and may as well contain oils or fats coming from the coating layer.

According to a further preferred embodiment, the pre-baked, edible product according to the present invention contains an added fat composition.

As described above, the added fat composition may for example be the layer of deep frying oil present on a deep-fried edible product after pre-baking the edible product in a deep fryer.

Preferably, the added fat composition contains, relative to the total weight of the added fat composition, less than 25.0 wt. %, preferably less than 20.0 wt. %, preferably less than 15.0 wt. %, of saturated fatty acid residues (SAFA).

Preferably, the added fat composition comprises at least one liquid oil.

Within the scope of this invention, it is understood that the expression “at least one liquid oil” refers to both one or more liquid oils, and that liquid oil should be understood both in the singular and in the plural.

Preferably, the liquid oil is present in an amount of at least 75.0 wt. %, preferably at least 85.0 wt. %, more preferably at least 95.0 wt. %, based on the total weight of the added fat composition. If so desired, the added fat composition consists entirely of a liquid oil.

Within the scope of this invention, it is also understood that the expression “the liquid oil is present in an amount of at least 75.0 wt. %, based on the total weight of the added fat composition” refers to the amount of the liquid oil present in the added fat composition when only one liquid oil is present, or refers to the sum of all amounts of liquid oils present in the added fat composition in case multiple liquid oils are present.

Non-limiting examples of liquid oils are, among others, conventional sunflower oil, sunflower oil having an increased content of oleic acid, corn oil, peanut oil, soybean oil, rapeseed oil, or combinations of two or more of these oils.

In other words, the fat components comprised in the glyceride composition of such a deep-fried edible product may thus partly originate from a layer or film of frying oil or fat that remains behind on the edible product after deep frying, the fats native to the product, as well as the fat composition used in the coating layer applied.

The present invention also provides a method for producing the pre-baked, edible product described above, comprising one or more coating layers.

The method for producing the pre-baked, edible product described above, comprising one or more coating layers, comprises the following steps:
Step 1: pre-baking or at least partially pre-baking the edible product, as described above,
Step 2: applying one or more coating layers [hereinafter “coating layer”] onto the pre-baked edible product,
   wherein the coating layer comprises, relative to the weight of the coating layer:
i. 75.0 to 100.0 wt. % of the fat composition, as described above
ii. 0 to 25.0 wt. % of the dry filler, as described above
iii. optionally, at most 15 wt. % of water,
   and wherein the fat composition of the coating layer is characterized by a content of from 35.0 to 80.0 wt. % of saturated fatty acid residues (SAFA) and less than 2.0 wt. % of trans fatty acid residues (TFA).

In a preferred embodiment, said fat composition in the coating layer contains at least one lauric fat component and at least one liquid fat component. The lauric fat component is preferably coconut oil.

In preferred embodiments, the fat composition present in the coating layer of the pre-baked, edible product of the present invention further contains, relative to the total weight of the fat composition:
A. 10.0 to 45.0 wt. % of saturated C12 fatty acid residues (C12:0),
B. less than 15.0 wt. % of saturated C16 fatty acid residues (C16:0),
C. saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 45.0,
D. triglycerides having a carbon number of 44 (C44), 46 (C46) and 48 (C48), of which the total content of C44, C46 and C48 is less than 15.0 wt. %.

In the method for producing the pre-baked, edible product according to the present invention, the fat composition present in the coating layer preferably contains from 20.0 to 40.0 wt. %, preferably from 25.0 to 38.0 wt. %, of saturated C12 fatty acid residues (C12:0), based on the total weight of the fat composition.

In the method for producing the pre-baked, edible product according to the present invention, the fat composition present in the coating layer preferably contains less than 12.0 wt. % of saturated C16 fatty acid residues (C16:0), based on the total weight of the fat composition.

In the method for producing the pre-baked, edible product according to the present invention, the fat composition present in the coating layer preferably contains from 45.0 to 75.0 wt. %, preferably from 50.0 to 70.0 wt. %, of saturated fatty acid residues (SAFA), based on the total weight of the fat composition.

In the method for producing the pre-baked, edible product according to the present invention, the fat composition present in the coating layer preferably contains less than 1.0 wt. % of trans fatty acid residues (TFA), based on the total weight of the fat composition.

In the method for producing the pre-baked, edible product according to the present invention, the fat composition present in the coating layer preferably contains a weight ratio of (C6:0+C8:0+C10:0+C12:0)/SAFA of more than 55.0.

In the method for producing the pre-baked, edible product according to the present invention, the total content of C44, C46 and C48 in the fat composition present in the coating layer is less than 10.0 wt. %, based on the total weight of the fat composition.

The above-mentioned characteristics of the fat composition present in the coating layer ensure that an optimum of functional and nutritional properties is achieved, as explained above.

According to a preferred embodiment, in the method for producing the pre-baked, edible product according to the present invention, the fat composition present in the coating layer of the pre-baked, edible product comprises, relative to the total weight of the fat composition,
a) 30.0 to 85.0 wt. % of coconut oil or at least one fraction of coconut oil, or combinations thereof, preferably from 50.0 to 75.0 wt. %, and
b) 15.0 to 70.0 wt. % of at least one liquid oil, preferably from 25.0 to 50.0 wt. %.

According to a particular embodiment, cold-pressed coconut oil, or the so-called “virgin” coconut oil, can be used. This coconut oil has retained its original taste and aroma, as it has not been subjected to high temperature processing.

In general, for liquid oil, different types and combinations of types may be suitable, such as for example, but not limited to, corn oil, soybean oil, sunflower oil, rapeseed oil, peanut oil, cottonseed oil, and the like, as well as varieties of these oils, such as for example sunflower oil having an increased content of oleic acid.

If so desired, the fat composition present in the coating layer of the pre-baked, edible product according to the present invention may comprise other oils and fats different from coconut oil and the liquid oil, in an amount of less than 30.0 wt. %, preferably less than 25.0 wt. %, relative to the total weight of the fat composition.

Non-limiting examples of other oils and fats are shea butter, sal fat, palm oil or fractions of the above, for example olein fractions, as these are less saturated. Animal fats, such as beef fat, pork fat, mutton fat, chicken fat, duck fat, goose fat, and the like, may also be used to a limited extent, usually with the aim of imparting a certain taste to the edible products baked to completion.

An important advantage of the method described herein is that when producing a pre-baked, edible product, particularly a deep-fried edible product, coconut oil in combination with a liquid oil can now be used, and that a final baked end product can be prepared having characteristics that closely resemble those of a classical product that has been deep-fried twice. As explained above, in the classical method, where only deep frying is used, a serious issue of foaming arises when using combinations coconut oil and liquid oil. For this reason, the use of coconut oil cannot be nutritionally optimized without the typical advantages of coconut oil being lost, such as for example by interesterification.

Preferably, in Step 1, when pre-baking or at least partially pre-baking the edible product, at least one deep frying step is used, in which a deep-fried edible product is formed.

This deep frying step is preferably carried out at temperatures of less than 185° C., preferably less than 180° C., in order to prevent the formation of unwanted components, such as oxidation products or acrylamide.

According to a preferred embodiment, in Step 1 of the method, the added fat composition is used in the deep frying step, as described above. Specifically, the added fat composition contains at least one liquid oil in an amount of at least 75.0 wt. %, preferably at least 85.0 wt. %, more preferably at least 95.0 wt. %, based on the total weight of the added fat composition. If so desired, the added fat composition consists entirely of a liquid oil.

Contrary to the examples from the prior art, in this invention, a non-hardened liquid oil can be used. For example, an oil can be used that is enriched in mono-unsaturated fatty acid residues, for the sake of stability at high baking temperatures. An example of such an oil is sunflower oil with an increased content of oleic acid, for example more than 75% of oleic acid, preferably more than 80% of oleic acid. However, if foaming can be avoided during deep frying, it is also possible to use oils with a higher content of polyunsaturated fatty acid residues.

Non-limiting examples of liquid oils are, among others, conventional sunflower oil, sunflower oil having an increased content of oleic acid, corn oil, soybean oil, rapeseed oil, peanut oil, and combinations of two or more of the above oils.

In addition to the liquid oil, another fat may be present up to at most 25%. Examples of this are shea butter, palm oil, sal fat, . . . or fractions thereof, e.g. oleins that are less saturated. Preferably, this other fat is not a lauric fat, as this leads to foaming during deep frying. It is also possible to use animal fats, if a specific taste is sought.

Preferably, the method for producing the pre-baked, edible product according to the present invention also comprises at least one deep freezing step, preferably 2 deep freezing steps.

This deep freezing step can be carried out on the pre-baked edible product formed in Step 1, or on the pre-baked, edible product comprising one or more coating layers formed in Step 2, or on both products, both after Step 1 and after Step 2.

In general, pre-baked, edible products are usually offered to the consumer in a deep-frozen state, who can then further store them in a stable manner in the freezer for consumption at home. This also increases the ease of use for the end user. Conventionally, in the case of edible products intended for final baking to completion by deep frying, the deep freezing takes place as a final step in the industrial preparation. As described above, in the method according to the present invention, a freezing step is preferably carried out as well on the pre-baked edible product formed in Step 1, whereby a deep-frozen pre-baked edible product is formed. This means that the coating layer in Step 2 is carried out on the deep-frozen pre-baked edible product. That way, the coating layer, which for a substantial part consists of the fat composition, as described above, and which is mainly applied in liquid form, can solidify quickly.

Applying the coating onto the pre-baked edible product in Step 2 can be carried out by using known coating techniques; such as for example by using spraying, atomization, submersion or dipping, enrobing, daubing techniques or any combinations thereof.

The spraying can be carried out by finely spraying an edible mixture containing the appropriate combination of oils and fats [hereinafter the fat mixture 1], in molten form, onto the pre-baked edible product, which is optionally deep-frozen, and which for example moves by means of a conveyor belt, over which one or more nozzles are arranged. Another possibility is that the pre-baked edible product, optionally deep-frozen, moves through a chamber into which the fat mixture 1 is atomized as a fine mist. An enrobing system may also be used for the coating, in which the pre-baked edible product, optionally deep-frozen, moves through a curtain of a falling fat mixture 1, in molten form. Such installations are used in the confectionery industry for enrobing products with chocolate.

The dipping can be carried out in a bath in which the fat mixture 1 is present in molten form. This fat mixture 1 may have a temperature of about ten or a few tens of degrees above the melting point of the fat mixture 1, e.g. 50 to 100° C., maar it may also have a higher temperature, even between 150 and 200° C., comparable to hot deep frying fat, but contrary to a deep frying step, the submerging only takes place for a short time, being less than 15 seconds, preferably less than 10 seconds, or preferably less than 5 seconds. This shows that the intention is to apply a coating layer, rather than to additionally bake the pre-baked edible product. The dipping at a higher temperature may have the advantage that the fat absorption by the pre-baked, edible product is lower, because it will drip off more easily after dipping. A comparable advantage is also achieved by opting for a process by using spraying or atomizing rather than dipping.

The pre-baked edible product, optionally deep-frozen, may also be daubed, for example by contacting it with a brush or similar device that has been moistened with the molten fat mixture 1. In order to limit the fat absorption after coating, the pre-baked, edible product comprising the coating layer can then be blown off. This is done before the coating is fully solidified, by using a forced stream of air, or preferably nitrogen, so as to avoid oxidation. This action also distributes the coating more homogenously over the pre-baked, edible product.

The present invention also provides the use of the pre-baked, edible product, comprising one or more coating layers, for the production of baked edible end products.

The present invention also provides a method for producing a baked edible end product wherein the pre-baked, edible product, comprising one or more coating layers, as described above, is finally baked to completion in an oven or by using hot air.

Thus, for the final baking to completion, it is preferable not to use a baking device, apparatus or installation in which the pre-baked, edible product, comprising one or more coating layers, is fully submerged in hot oil. In other words, the final baking to completion preferably does not consist of the classical deep frying step.

According to a preferred embodiment, the pre-baked, edible product, comprising one or more coating layers, as described above, is finally baked to completion by using devices such as for example conventional ovens, hot air ovens, microwave ovens, hot air fryers (air fryer) or similar devices, grilling appliances.

Depending on the type of device, the optimal time and temperature for the baking to completion may differ. Often, hot air ovens are used, since those are available in virtually every household. For such devices, the baking temperature will usually be between 175 and 225° C., and the baking time between 10 and 15 minutes.

Since the pre-baked, edible product, comprising one or more coating layers, as described above, is usually deep-frozen, this also means that the product, when baking to completion, will first thaw out.

Processes without a final deep frying step offer many advantages, including ease of use, but also nutritional and health advantages, such as lower fat absorption by the edible product and lower absorption of oxidized fat components present in frying oil in case of multiple uses.

The present invention also provides the use of a fat composition for producing the coating layer of the pre-baked, edible product, as described above.

In a preferred embodiment, said fat composition contains at least one lauric fat component and at least one liquid fat component. The lauric fat component is preferably coconut oil.

In preferred embodiments, the fat composition contains, relative to the total weight of the fat composition:
A. 10.0 to 45.0 wt. % of saturated C12 fatty acid residues (C12:0),
B. less than 15.0 wt. % of saturated C16 fatty acid residues (C16:0),
C. 35.0 to 80.0 wt. % of saturated fatty acid residues (SAFA),
D. less than 2.0 wt. % of trans fatty acid residues (TFA)
E. saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 45.0,
F. triglycerides having a carbon number of 44 (C44), 46 (C46) and 48 (C48), of which the total content of C44, C46 and C48 is less than 15.0 wt. %.

In further preferred embodiments, said fat composition contains from 20.0 to 40.0 wt. %, preferably from 25.0 to 38.0 wt. %, of saturated C12 fatty acid residues (C12:0), based on the total weight of the fat composition.

In further preferred embodiments, said fat composition contains less than 12.0 wt. % of saturated C16 fatty acid residues (C16:0), based on the total weight of the fat composition.

In further preferred embodiments, said fat composition contains from 45.0 to 75.0 wt. %, preferably from 50.0 to 70.0 wt. %, of saturated fatty acid residues (SAFA), based on the total weight of the fat composition.

In further preferred embodiments, said fat composition contains less than 1.0 wt. % of trans fatty acid residues (TFA), based on the total weight of the fat composition.

In further preferred embodiments, said fat composition contains a weight ratio of (C6:0+C8:0+C10:0+C12:0)/SAFA of more than 55.0.

In further preferred embodiments, said fat composition contains a total content of C44, C46 and C48 of less than 10.0 wt. %, based on the total weight of the fat composition.

In further preferred embodiments, said fat composition is characterized by a ratio of PUFA/MUFA of at least 0.5 and at most 2.5, preferably at least 1.0 and at most 2.0.

The present invention will be further illustrated by the examples and comparative examples below.

### 4. EXAMPLES

All mixing ratios, contents and concentrations in the present document are expressed in weight units and weight percent, unless otherwise specified.

### Materials

deep-frozen, pre-baked potato fries of the “Steakhouse” type, hereinafter referred to as “French fries SH”

### Example 1: Production of a Baked Edible End Product According to the Method of the Present Invention

The “French fries SH” contain 3.5 wt. % of fat, and the fat (i.e. added fat composition) is composed of sunflower oils. The fat was extracted by hexane extraction and the fatty acid residue concentrations and carbon number (C no.) were determined by gas chromatography. The characteristics of the added fat composition, specifically the fatty acid residue concentrations and carbon number (C no.), are summarized in Table 1.

TABLE 1
Fatty acid residue concentrations (wt. %)

| | |
|---|---|
| C6:0 | <0.1 |
| C8:0 | <0.1 |
| C10:0 | <0.1 |
| C12:0 | <0.1 |
| C14:0 | <0.1 |
| C16:0 | 6.7 |
| C18:0 | 3.6 |
| C18:1 | 36.1 |
| C18:2 | 51.3 |
| C18:3 | 0.2 |
| C20:0 | 0.3 |
| Other | 1.8 |
| TFA | 0.4 |
| C no. | |
| C44 + C46 + C48 | <10 |

The deep-frozen “French fries SH” were coated with a coating. This coating was obtained by dipping the French fries for about 1 second in a cup filled with a fat mixture 1 in a molten state. To this end, the fat mixture 1 was heated to 40° C. After the dipping, the coated French fries were immediately placed on a grid to drip off, and a force stream of hot air of about 60° C. was blown over them to blow off excess fat.
Then, the deep-frozen “French fries SH” provided with a coating were immediately deep-frozen again.
The following fat mixtures 1 were used:

Fat mixture 1A: Coconut oil/corn oil in a 70/30 ratio

Fat mixture 1B: Coconut oil/corn oil in a 50/50 ratio

Fat mixture 1C: Coconut oil/corn oil in a 30/70 ratio

Comparative Fat mixture 1 D: 100% Coconut oil

The characteristics of the fat mixtures 1, specifically the fatty acid residue concentrations and carbon number (C no.) are summarized in Table 2.

TABLE 2

| Fat mixtures | 1A | 1B | 1C | 1D |
|---|---|---|---|---|
| | Fatty acid residue concentrations | | | |
| | (wt. %) | | | |
| C6:0 | 0.6 | 0.5 | 0.3 | 0.9 |
| C8:0 | 4.8 | 3.4 | 2.0 | 6.8 |
| C10:0 | 3.9 | 2.8 | 1.7 | 5.5 |
| C12:0 | 32.8 | 23.4 | 14.0 | 46.8 |
| C14:0 | 13.2 | 9.4 | 5.6 | 18.8 |
| C16:0 | 10.2 | 10.6 | 11.0 | 9.7 |
| C18:0 | 2.6 | 2.4 | 2.1 | 2.9 |
| C18:1 | 14.6 | 19.7 | 24.8 | 6.9 |
| C18:2 | 16.8 | 26.9 | 37.0 | 1.7 |
| C18:3 | 0.3 | 0.5 | 0.6 | 0.0 |
| C20:0 | 0.1 | 0.2 | 0.3 | 0.0 |
| Other | 0.2 | 0.3 | 0.6 | 0.0 |
| C no. | content (wt. %) | | | |
| C44 + C46 + C48 | <10 | <10 | <10 | <10 |
| TFA | <0.1 | <0.1 | <0.1 | <0.1 |
| SAFA | 68.1 | 52.6 | 37.0 | 91.4 |
| (C6:0 + C8:0 + C10:0 + C12:0)/SAFA | 61.7 | 57.0 | 48.6 | 65.6 |

With each fat mixture 1, 10 “French fries SH” were coated in total, all of similar size. The French fries were weighed before and after coating. The fat absorption after coating, expressed in wt. % relative to uncoated product, for the different fat mixtures 1 are summarized in Table 3.

TABLE 3

| | Wt. % |
|---|---|
| Fat mixture 1A | 6.10 |
| Fat mixture 1B | 6.29 |
| Fat mixture 1C | 4.30 |
| Fat mixture 1D | 6.88 |

The deep-frozen “French fries SH” coated by using the fat mixtures 1A, 1B and 1C are hereinafter referred to as “example product 1”, “example product 2” and “example product 3”. These are all products according to the present invention.
The deep-frozen “French fries SH” coated by using the comparative fat mixture 1D are hereinafter referred to as “comparative product 4”. This is a comparative example.
Based on the fatty acid residue composition and the fat content of the uncoated “French fries SH”, and the average fat absorption during coating, and the fatty acid residue composition of the fat mixtures 1A, 1 B, 1C and the comparative fat mixture 1D that were used, the average fatty acid residue composition and carbon number of the coated “French fries SH” were determined.
The characteristics of the example products 1 (P1), 2 (P2) and 3 (P3) and the comparative product 4 (CP4), specifically the fatty acid residue concentrations, the carbon number (C no.) in the glyceride composition, and the SAFA and TFA of the fat composition in the coating layer are shown in Table 4.

TABLE 4

| | P1 | P2 | P3 | CP4 |
|---|---|---|---|---|
| | Fatty acid residue | | | |
| | concentrations (wt. %) in | | | |
| | glyceride composition | | | |
| C6:0 | 0.4 | 0.3 | 0.1 | 0.6 |
| C8:0 | 3.0 | 2.2 | 0.9 | 3.6 |
| C10:0 | 2.4 | 1.8 | 0.9 | 3.6 |
| C12:0 | 20.8 | 15.0 | 7.7 | 31.0 |
| C14:0 | 8.4 | 6.0 | 3.1 | 12.5 |
| C16:0 | 8.9 | 9.2 | 9.1 | 8.7 |
| C18:0 | 3.0 | 2.8 | 2.8 | 3.1 |
| C18:1 | 22.4 | 25.6 | 29.9 | 16.7 |
| C18:2 | 29.4 | 35.6 | 43.4 | 18.4 |
| C18:3 | 0.3 | 0.4 | 0.4 | 0.1 |
| Total C18 | 55.0 | 64.4 | 76.5 | 38.4 |
| C20:0 | 0.2 | 0.2 | 0.3 | 0.1 |
| other | 0.8 | 0.8 | 1.1 | 0.6 |
| | content (wt. %) in glyceride | | | |
| | composition | | | |
| SAFA | 47.1 | 37.6 | 25.2 | 64.2 |
| TFA | <0.5 | <0.5 | <0.5 | <0.5 |
| (C6:0 + C8:0 + C10:0 + C12:0)/SAFA | 56.6 | 51.3 | 39.4 | 62.0 |
| (C14:0 + C16:0)/SAFA | 36.7 | 40.6 | 48.3 | 33.0 |
| C44 + C46 + C48 | <0.1 | <0.1 | <0.1 | <0.1 |
| PUFA/MUFA | 1.32 | 1.41 | 1.47 | 1.10 |
| | content (wt. %) in fat | | | |
| | composition in coating layer | | | |
| SAFA | 68.1 | 52.6 | 37.0 | 91.4 |
| TFA | <0.1 | <0.1 | <0.1 | <0.1 |

The coated “French fries SH” were stored for 2 days in a freezer at −18° C. After this storage time, the French fries were baked in a hot air oven, brand: Steba; type: Backofen KB28 1500 Watt; ventilation setting: circulating air. The French fries were placed on a grid that was placed in the oven, which was pre-heated to 220° C. The French fries were baked to completion in the oven at this temperature, under continuous ventilation with hot air, for 12 minutes. During baking, excess fat was allowed to drip off of the French fries.
The example products 1 (P1), 2 (P2) and 3 (P3) and the comparative product 4 (CP4) were simultaneously baked to completion in the same oven under the same conditions, as described above.
Next, the French fries baked to completion were each assessed by a member of a test panel, which consisted of 8 persons in total. The French fries were judged on a number of parameters, but mainly organoleptic criteria.
The panel members were asked to assign a score between 0 and 5 for the parameters “crispiness on the outside”, “texture of the inside” and “color”.
The grades assigned have the following meanings:
“crispiness on the outside”: 0 means not crispy at all (i.e., soft); 5 means very crispy.
“texture of the inside”: 0 means not OK at all due to being insufficiently baked, raw, or due to being overly baked, dry, mealy. 5 is an ideal score for tender, creamy, right humidity.
“color”: ideal color is a golden yellow and receives a score of 5; if the color is clearly too light or too dark, a lower grade is assigned.
   The panel members were also asked to assign a score of +1, 0 or −1 for the parameter “French fries taste”, wherein +1 means that the French fries are organoleptically close to the characteristics of classical French fries baked in a deep fryer. A score of 0 means this is not clearly present, and a score of −1 means the properties strongly differ from those of classical French fries, in a negative sense.
   Finally, they were asked to indicate, based on the evaluation, which sample was preferred.
   The assessment by the test panel yielded results which are summarized in Table 5.

TABLE 5

| | French | | | Color | Preference |
|---|---|---|---|---|---|
| | fries | Crispy | Texture | golden | (number of |
| | taste | outside | inside | yellow | times) |
| Example product 1 | 0.9 | 4.1 | 3.4 | 4.0 | 6× |
| Example product 2 | 0.1 | 3.3 | 2.8 | 3.6 | |
| Example product 3 | 0.1 | 3.0 | 2.6 | 3.8 | 2× |
| Comparative | −0.6 | 2.4 | 2.1 | 3.1 | |
| product 4 | | | | | |

The assessment by the test panel allows the following conclusions:

The product coated with the fat mixture 1A, Coconut oil/Corn oil in a ratio of 70/30, scores the highest across the board: for all parameters, “crispiness on the outside”, “texture of the inside”, “color” and “French fries taste”, this product received the best scores.

Most striking is the strong similarity to classical French fries, seemingly due to a crispy outside combined with a tender, creamy inner texture. This product scored particularly well for the latter parameter, suggesting that the fries were sufficiently baked without being dried out.

The other fat mixtures 1B and 1C, in which coconut oil and corn oil were combined, also scored relatively well, albeit slightly lower.

Most striking is the relatively weak score for the French fries coated in pure coconut oil, comparative fat mixture 1 D. Although the pure coconut oil is the fat composition with the highest content of solid fat, and therefore said fat composition could be expected to score the highest for crispiness, this turns out not to be the case in testing. Moreover, the inside of this product was described by a number of panel members as “dry”.

Thus, we have surprisingly found that adding a liquid oil to coconut oil, to be used as a coating fat mixture 1 on French fries for baking to completion in the oven, leads to an improvement in crispiness of the outside and to a more pleasant, tender inner texture, which strongly resembles the model product, being the classical French fry baked in a deep fryer. The most optimal addition of liquid oil is in the range of a 70/30 ratio of coconut oil/liquid oil. If the proportion of liquid oil in het coating fat is further increased, the crispy character starts to decline. The tender inner texture also appears to be related to this. This means that according to the present invention, a final baked edible end product was developed that is not only healthier, but also improved in terms of organoleptics, although these were initially considered as mutually conflicting interests.

1. Pre-baked, edible product, suitable for being baked to completion in an oven or by using hot air, wherein the pre-baked, edible product comprises one or more coating layers [hereinafter “coating layer”] and wherein the pre-baked, edible product contains 2.5 to 20.0 wt. % of a glyceride composition, relative to the total weight of the pre-baked, edible product, wherein the glyceride composition comprises at least one lauric fat component and at least one liquid fat component, and wherein the glyceride composition contains, relative to the weight of the glyceride composition:
a) 5.0 to 35.0 wt. % of saturated C12 fatty acid residues (C12:0),
b) less than 12.0 wt. % of saturated C16 fatty acid residues (C16:0),
c) 30.0 to 80.0 wt. % of saturated and unsaturated C18 fatty acid residues (C18)
d) 20.0 to 70.0 wt. % of saturated fatty acid residues (SAFA),
e) less than 2.0 wt. % of trans fatty acid residues (TFA)
f) saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 37.0,
g) saturated C14 fatty acid residues (C14:0), saturated C16 fatty acid residues (C16:0), and saturated fatty acid residues (SAFA), in a weight ratio of (C14:0+C16:0)/SAFA of less than 50.0,
wherein the coating layer comprises 75.0 to 100.0 wt. % of a fat composition, relative to the total weight of the coating layer, and wherein the fat composition of the coating layer is characterized by a content of from 35.0 to 80.0 wt. % of saturated fatty acid residues (SAFA) and less than 2.0 wt. % of trans fatty acid residues (TFA).

2. The pre-baked, edible product according to claim 1, characterized in that the glyceride composition contains, relative to the weight of the glyceride composition, from 7.0 to 30.0 wt. %, preferably from 9.0 to 28.0 wt. %, preferably from 10.0 to 25.0 wt. %, of saturated C12 fatty acid residues (C12:0).

3. The pre-baked, edible product according to claim 1 or claim 2, characterized in that the glyceride composition contains, relative to the weight of the glyceride composition, less than 10.0 wt. % of saturated C16 fatty acid residues (C16:0).

4. The pre-baked, edible product according to any one of claims 1-3, characterized in that the glyceride composition contains, relative to the weight of the glyceride composition, from 35.0 to 77.0 wt. %, preferably from 40.0 to 75.0 wt. %, of saturated and unsaturated C18 fatty acid residues (C18)

5. The pre-baked, edible product according to any one of claims 1-4, characterized in that the glyceride composition contains, relative to the weight of the glyceride composition, from 25.0 to 65.0 wt. %, preferably from 30.0 to 60.0 wt. %, of saturated fatty acid residues (SAFA).

6. The pre-baked, edible product according to any one of claims 1-5, characterized in that the glyceride composition contains, relative to the weight of the glyceride composition, less than 1.0 wt. % of trans fatty acid residues (TFA).

7. The pre-baked, edible product according to any one of claims 1-6, characterized in that the glyceride composition contains, relative to the weight of the glyceride composition a weight ratio of (C6:0+C8:0+C10:0+C12:0)/SAFA of more than 40.0, preferably more than 45, preferably more than 50.

8. The pre-baked, edible product according to any one of claims 1-7, characterized in that the glyceride composition contains, relative to the weight of the glyceride composition a weight ratio of (C14:0+C16:0)/SAFA of less than 45.0, preferably less than 40.

9. The pre-baked, edible product according to any one of claims 1-8, characterized in that the glyceride composition contains triglycerides having a carbon number (CN) with a length of between 44 carbon atoms (C44) and 48 carbon atoms (C48), and wherein the sum C44+C46+C48 is less than 15.0 wt. %, preferably less than 10.0 wt. %, relative to the weight of the glyceride composition.

10. The pre-baked, edible product according to any one of claims 1-9, characterized in that the glyceride composition contains poly-unsaturated fatty acid residues (PUFA) and mono-unsaturated fatty acid residues (MUFA) in a weight ratio (PUFA)/(MUFA) of at least 0.5 and at most 2.5, preferably at least 1.0 and at most 2.0.

11. The pre-baked, edible product according to any one of claims 1-10, characterized in that the coating layer further comprises, relative to the total weight of the coating layer:
i. at most 25.0 wt. % of a fat-free portion,
ii. optionally, at most 15 wt. % of water.

12. The pre-baked, edible product according to claim 11, characterized in that the fat composition in the coating layer contains at least one lauric fat component and at least one liquid fat component.

13. The pre-baked, edible product according to claim 12, characterized in that the lauric fat component is coconut oil.

14. The pre-baked, edible product according to any one of claims 1-13, characterized in that the fat composition of the coating layer further contains, relative to the total weight of the fat composition:
A. 10.0 to 45.0 wt. % of saturated C12 fatty acid residues (C12:0),
B. less than 15.0 wt. % of saturated C16 fatty acid residues (C16:0),
C. saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 45.0,
D. triglycerides having a carbon number of 44 (C44), 46 (C46) and 48 (C48), of which the total content of C44, C46 and C48 is less than 15.0 wt. %.

15. The pre-baked, edible product according to any one of claims 1-14, characterized in that the fat composition contains, relative to the weight of the fat composition, from 20.0 to 40.0 wt. %, preferably from 25.0 to 38.0 wt. %, of saturated C12 fatty acid residues (C12:0).

16. The pre-baked, edible product according to any one of claims 1-15, characterized in that the fat composition contains, relative to the weight of the fat composition, less than 12.0 wt. % of saturated C16 fatty acid residues (C16:0).

17. The pre-baked, edible product according to any one of claims 1-16, characterized in that the fat composition contains, relative to the weight of the fat composition, from 45.0 to 75.0 wt. %, preferably from 50.0 to 70.0 wt. %, of saturated fatty acid residues (SAFA).

18. The pre-baked, edible product according to any one of claims 1-17, characterized in that the fat composition contains, relative to the weight of the fat composition, less than 1.0 wt. % of trans fatty acid residues (TFA).

19. The pre-baked, edible product according to any one of claims 1-18, characterized in that the fat composition contains, relative to the weight of the fat composition, a weight ratio of (C6:0+C8:0+C10:0+C12:0)/SAFA of more than 55.0.

20. The pre-baked, edible product according to any one of claims 1-19, characterized in that the fat composition contains, relative to the weight of the fat composition, triglycerides having a carbon number (CN) with a length of between 44 carbon atoms (C44) and 48 carbon atoms (C48), and wherein the sum C44+C46+C48 is less than 10.0 wt. %.

21. The pre-baked, edible product according to any one of claims 1-20, characterized in that the fat composition comprises, relative to the weight of the fat composition:
a) 30.0 to 85.0 wt. % of coconut oil or at least one fraction of coconut oil, or combinations thereof, preferably from 50.0 to 75.0 wt. %, and
b) 15.0 to 70.0 wt. % of at least one liquid oil, preferably from 25.0 to 50.0 wt. %.

22. The pre-baked, edible product according to claim 21, characterized in that the at least one liquid oil is selected from the group consisting of corn oil, soybean oil, sunflower oil, rapeseed oil, peanut oil, cottonseed oil, and varieties of these oils.

23. The pre-baked, edible product according to claim 21 or claim 22, characterized in that the fat composition further comprises other oils and fats different from the coconut oil and from the liquid oil, in an amount of less than 30.0 wt. %, preferably less than 25.0 wt. %, relative to the total weight of the fat composition.

24. The pre-baked, edible product according to any one of claims 1-23, characterized in that the pre-baked, edible product comprises substantially no hardened fat components.

25. The pre-baked, edible product according to any one of claims 1-24, characterized in that the pre-baked, edible product comprises substantially no palm oil or palm kernel oil, or fractions of these oils.

26. The pre-baked, edible product according to any one of claims 1-25, characterized in that the pre-baked, edible product comprises substantially no animal fat components.

27. The pre-baked, edible product according to any one of claims 1-26, characterized in that the pre-baked, edible product is a pre-baked potato product.

28. The pre-baked, edible product according to any one of claims 1-26, characterized in that the pre-baked, edible product is a deep-fried edible product.

29. The pre-baked, edible product according to claim 28, characterized in that the deep-fried edible product is selected from the group consisting of French fries, croquettes, pommes archiduc, deep-fried potatoes or potato pieces.

30. The pre-baked, edible product according to claim 28 or claim 29, characterized in that the pre-baked, edible product is a deep-fried, deep-frozen edible product.

31. A method for producing the pre-baked, edible product, comprising one or more coating layers, according to any one of claims 1-30, comprising the following steps:
Step 1: pre-baking or at least partially pre-baking an edible product,
Step 2: applying one or more coating layers [hereinafter “coating layer”] onto the pre-baked edible product,
wherein the coating layer comprises, relative to the weight of the coating layer:
i. 75.0 to 100.0 wt. % of a fat composition
ii. 0 to 25.0 wt. % of a dry filler
iii. optionally, at most 15 wt. % of water,
and wherein the fat composition of the coating layer is characterized by a content of from 35.0 to 80.0 wt. % of saturated fatty acid residues (SAFA) and less than 2.0 wt. % of trans fatty acid residues (TFA).

32. The method according to claim 31, characterized in that in Step 1, at least one deep frying step is employed, in which a deep-fried edible product is formed.

33. The method according to claim 31 or claim 32, characterized in that in the at least one deep frying step, an added fat composition is used which contains, relative to the total weight of the added fat composition, less than 25.0 wt. %, preferably less than 20.0 wt. %, preferably less than 15.0 wt. %, of saturated fatty acid residues (SAFA).

34. The method according to any one of claims 31-33, characterized in that the method comprises at least one deep freezing step, preferably 2 deep freezing steps.

35. The method according to claim 34, characterized in that a freezing step is applied to the pre-baked edible product formed in Step 1, wherein a deep-frozen pre-baked edible product is formed.

36. The method according to any one of claims 31-35, characterized in that applying the coating layer onto the pre-baked edible product in Step 2 may be carried out by using techniques selected from the group consisting of spraying, atomizing, submerging or dipping, enrobing, daubing or combinations of these.

37. A method for producing a baked edible end product wherein the pre-baked, edible product, comprising one or more coating layers, according to any one of claims 1-30, is finally baked to completion in an oven or by using hot air.

38. The method according to claim 37, characterized in that the final baking to completion is carried out by using appliances selected from the group consisting of conventional ovens, hot air ovens, microwave ovens, hot air fryers (air fryer) and grilling appliances.

39. A use of a fat composition for producing the coating layer of the pre-baked, edible product, according to any one of claims 1-30, wherein said fat composition contains at least one lauric fat component and at least one liquid fat component, and the fat composition contains, relative to the total weight of the fat composition:
A. 10.0 to 45.0 wt. % of saturated C12 fatty acid residues (C12:0),
B. less than 15.0 wt. % of saturated C16 fatty acid residues (C16:0),
C. 35.0 to 80.0 wt. % of saturated fatty acid residues (SAFA),
D. less than 2.0 wt. % of trans fatty acid residues (TFA)
E. saturated C6 fatty acid residues (C6:0), saturated C8 fatty acid residues (C8:0), saturated C10 fatty acid residues (C10:0), saturated C12 fatty acid residues (C12:0) and saturated fatty acid residues (SAFA), in a weight ratio of (C6:0+C8:0+C10:0+C12:0)/SAFA of more than 45.0,
F. triglycerides having a carbon number of 44 (C44), 46 (C46) and 48 (C48), of which the total content of C44, C46 and C48 is less than 15.0 wt. %.
